(19) United States
(12) Patent Application Publication
(10) Pub. No.: US 2006/0066082 A1
(43) Pub. Date: Mar. 30, 2006

(54) Horn switch device, airbag system, and steering device

(75) Inventors: Kei Tsujimoto, Hikone-shi (JP); Yoshitaka Matsui, Kanzaki-gun (JP); Wataru Nakazawa, Higashioumi-shi (JP)

Correspondence Address: KANESAKA BERNER AND PARTNERS LLP, SUITE 300, 1700 DIAGONAL RD, ALEXANDRIA, VA, 22314-2848, US

(73) Assignee: TAKATA CORPORATION, Tokyo (JP)

(21) Appl. No.: 11/226,238

(22) Filed: Sep. 15, 2005

(30) Foreign Application Priority Data
Sep. 24, 2004 (JP) 2004-277288

(51) Int. Cl. B60R 21/16

(52) U.S. Cl. 280/731

(57) ABSTRACT

In order reduce the number of components of a horn switch device that is mounted to a steering wheel for vehicles, an airbag module of a steering device is constructed such that guide nuts are used as both fixing means for fixing a link mechanism to a retainer and fixing means for fixing an inflator to the retainer.

### BACKGROUND OF THE INVENTION AND RELATED ART STATEMENT

The present invention relates to a construction technique for a horn switch device mounted to a vehicular steering wheel.

A steering device structure in which a horn mechanism is mounted to a steering wheel for vehicles is known, for example, from Japanese Unexamined Patent Application Publication No. 10-100832.

The steering device described in this document is constructed such that when an airbag cover that is used as a depression member (e.g. as a horn button) is manually depressed by a vehicle's occupant to sound the vehicle horn, a moving contact is brought into contact with a fixed contact, operating the horn mechanism and energizing the horn.

The above mentioned patent document discloses a structure in which a horn mechanism is mounted to a steering wheel of a vehicle. This type of arrangement however typifies the need for a technique to minimize the number of components which are required.

The present invention has been made in view of such circumstances, and has as an object the provision of a technique advantageous in reducing the number of components in a horn switch device mounted to a steering wheel for vehicles.

### SUMMARY OF THE INVENTION

In order to achieve the above-mentioned object, the present invention has been proposed. Embodiments of the invention can be applied to a construction technique for a horn switch device mounted to a steering wheel of a vehicle such as automobile.

A first aspect of the invention resides in a horn switch device which is provided in the position on a steering wheel for vehicles at which a steering-wheel side member and a depression-part side member are opposed to each other. The horn switch device has a structure in which a first horn switch contact and a second horn switch contact are brought into contact with each other by the depression of a depression part or member in response to a manually induced operation intended to sound the horn, and in which the contact between the first horn switch contact and the second horn switch contact is broken by removing the depression of the depression part to cease the operation of the horn.

Here, the term “depression part” typically includes a module cover (module pad) that covers the airbag of the steering wheel from the occupant side, a horn operating cover used only to activate the horn, and a horn operating button (switch). The term “steering-wheel side member” broadly includes the steering wheel itself and various members fixed to the steering wheel. The term “depression-part side member” broadly includes a depression part that is directly depressed at depression of the horn and various members fixed to the depression part.

The horn switch device according to the invention has a structure in which the device is fixed to the depression-part side member via first fixing means, and the first fixing means is also used as second fixing means for fixing a plurality of the depression-part side members. As the first fixing means and the second fixing means, typically, a bolt-nut structure, a rivet structure, or the like is used.

Since the horn switch device according to the first aspect of the invention uses the first fixing means also as the second fixing means, the number of components are reduced, increasing the versatility of the components to reduce the cost, thereby achieving simplification.

A second aspect of the second invention resides in a horn switch device which has at least a plurality of plate-like horn plates; first support means; second support means; and biasing means in the position where the steering-wheel side member and the depression-part side member are opposed to each other.

The plurality of plate-like horn plates in this arrangement is joined together with a rotation shaft and is allowed to rotate around the rotation shaft.

The first support means according to this aspect of the invention, supports a first support section of the horn plates and is fixed to the steering-wheel side member. In other words, the horn plates are fixed to the steering-wheel side member via the first support means. The second support means of the invention fixes a second support section of the horn plates, different from the first support section, and is fixed to the depression-part side member via the first fixing means. That is to say, the horn plates are fixed to the depression-part side member via the first support means and the second support means. Here the term “horn plates support” broadly includes a structure in which the horn plates are clamped from both sides and a structure in which the horn plates are supported from the top or bottom.

The biasing means, referred to above, comprises an arrangement or means for biasing the horn plates so as to rotate around the rotation shaft in a first rotating direction. The biasing means has only to have sufficient biasing force to rotate the horn plates in the first rotating direction and its biasing position is not limited. For example, the biasing means may directly bias the horn plates themselves or, alternatively, the biasing means may bias the rotation shaft of the horn plates. As the biasing means, a spring, a damper mechanism, and means using the restoring force of the material itself (viz., a flexible cantilever like arrangement) may be used.

In accordance with this aspect of the invention, the depression-part side member is brought close to the steering-wheel side member by the depression of the depression part to move the first support means relative to the second support means. At this time, the horn plates rotate in a second rotating direction opposite to the first rotating direction around the rotation shaft against the biasing force of the biasing means, with the first support section supported on the steering wheel side by the first support means and the second support section supported to the depression part side by the second support means. Thus, the first horn switch contact and the second horn switch contact are brought into contact with each other to sound the horn. On the other hand, the depression-part side member is separated from the steering-wheel side member by releasing the depression of the depression part to move the first support means and the second support means relative to one another. At this time, the horn plates rotate in the first rotating direction around the rotation shaft by the biasing force of the biasing means, with the first support section supported to the steering wheel side by the first support means and the second support section supported to the depression part side by the second support means. Thus, the contact between the first horn switch contact and the second horn switch contact is released to stop horn operation (viz., turn the horn off).

The direction in which the first support means and the second support means move relative to one another in response to the depression of the depression part or removal of the depressing force may either concur with the relative movement of the depression-part side member and the steering-wheel side member or may be the reverse.

With the horn switch device according to the second aspect of the invention, the horn plates rotate only in the first rotating direction or the second rotating direction around the rotation shaft, with the first support section supported on the steering wheel side by the first support means and the second support section supported on the depression part side by the second support means. Accordingly, the motion of the depression part is limited to one direction during the operation of the horn. Accordingly, whichever part of the depression part such as the center or the end, the occupant of the vehicle depresses, the pressure produced by the depression is applied evenly onto the depression part, allowing the pressure required to sound the horn to be maintained constant irrespective of the depression position of the depression part. Consequently, the operability of the horn can be improved by smoothing the motion of the depression part.

Also since the motion of the depression part during the operation of the horn is limited to one direction, the gap formed between the outer periphery of the depression part and the steering wheel can be minimized, enhancing the appearance.

A third aspect of the invention resides in a horn switch device wherein the plurality of horn plates of the type referred to above, is constructed of a pair of right and left horn plates. This structure reduces the cost by sharing two horn plates.

A fourth aspect of the invention resides in that the above-mentioned plurality of horn plates are joined together to form a ring shape having a central hole and the central hole is fitted on a horn-plate adjacent member. Here the term “the horn-plate adjacent member” broadly includes members adjacent to the horn plates with the horn plates assembled. A typical example of the horn-plate adjacent member is an inflator that is disposed in a position above and adjacent to the horn plates and supplies inflation gas to the airbag.

The structure according this fourth aspect of the invention can decrease the size of the devices in the direction in which the horn plates and the horn-plate adjacent member are adjacent to each other, achieving size reduction.

A fifth aspect of the invention resides in a horn switch device which, when applied to a selected one of the above-mentioned structures, is such that the first support means includes first clamp means and the second support means includes second clamp means. The first clamp means is fixed to the steering-wheel side member while clamping the first support section of each horn plate from the top and bottom of the plate and allows the rotation of the horn plates around the rotation shaft in the clamped state. The second clamp means is fixed to the depression-part side member while clamping the second support section of each horn plate from the top and bottom of the plate and allows the rotation of the horn plates around the rotation shaft in the clamped state.

With the structure according to the fifth aspect of the invention, the horn plates are securely supported while being clamped from the top and bottom, further smoothing the rotation around the rotation shaft.

A sixth aspect of the invention resides in an airbag system which includes at least the horn switch device of the type mentioned above; a vehicle airbag; a retainer; an inflator; an airbag cover; and a horn operating member. The vehicle airbag has the function of deploying in an occupant protection region in a collision. The retainer has the function of accommodating the vehicle airbag folded in a desired form in advance. The inflator serves as gas supply means for supplying inflation gas to the vehicle airbag. The airbag cover has the function of covering the part of the vehicle airbag adjacent to the occupant.

In a vehicle collision, the airbag cover is cleaved by the deploying force of the vehicle airbag, allowing the vehicle airbag to deploy in the occupant protection region. The horn operating member is a member that is operated by the occupant when the horn is activated. In the airbag system according to the invention, the horn is activated by the depression of the horn operating member serving as the depression part and the operation of the horn is cancelled by canceling the depression of the horn operating member. The horn operating member typically includes a pad member, a button, and a switch.

According to this sixth aspect of the invention, there is provided an airbag system in which the number of components of the horn switch device is reduced.

In an airbag system according to the sixth aspect of the invention, the horn operating member may be provided only to operate the horn in isolation from the airbag cover or, alternatively, it may also be used as the airbag cover. When the horn operating member is also used as the airbag cover, the horn operating member may operate together with the retainer side member by depression or, alternatively, may operate in isolation from the retainer side member. In other words, the horn operating member may be of a so-called cover floating (pad floating) type in which the horn operating member floats on the retainer.

A seventh aspect of the invention resides in a steering device which includes at least a steering wheel for steering a vehicle, to which a horn switch device is mounted; a vehicle airbag; a retainer; an inflator; an airbag cover; and a horn operating member. Those components are disposed inside the outline of the steering wheel. The components of the invention, such as the vehicle airbag, the retainer, the inflator, the airbag cover, and the horn operating member, have substantially the same structure as those described in accordance with the sixth aspect.

In the steering device of this aspect of the invention, the horn is activated by the depression of the horn operating member serving as the depression part and the operation of the horn is stopped by removing the depressing force which is applied to the horn operating member.

According to this aspect of the invention there is provided a steering device in which the number of components of the horn switch device is reduced.

As has been described, in the horn switch device for vehicles according to the various aspects of the invention, since the first fixing means for fixing the horn switch device to the depression-part side member is used as the second fixing means for fixing the plurality of depression-part side members, the number of the components can be reduced.

### BRIEF DESCRIPTION OF THE DRAWINGS

FIG. 1 is a plan view showing the appearance of a steering device to which embodiments of the invention are applied.

FIG. 2 is an exploded perspective view of an airbag module which is provided in the steering device depicted in FIG. 1.

FIG. 3 is a perspective view of the airbag module which is provided in the steering device depicted in FIG. 1, as viewed from the back.

FIG. 4 is a perspective view of a link mechanism according to an embodiment of the invention.

FIG. 5 is an exploded view of a part of the link mechanism disposed in position S2 depicted in FIG. 4.

FIG. 6 is a side schematic view of the link mechanism shown in FIG. 4 viewed in the direction of arrow A, showing a state before a horn pad is depressed.

FIG. 7 is a side schematic view of the link mechanism in FIG. 4 as viewed in the direction of arrow A, showing a state when the horn pad is depressed.

### DETAILED DESCRIPTION OF PREFERRED EMBODIMENTS

An embodiment of the steering device of the present invention will be specifically described hereinafter with reference to the drawings.

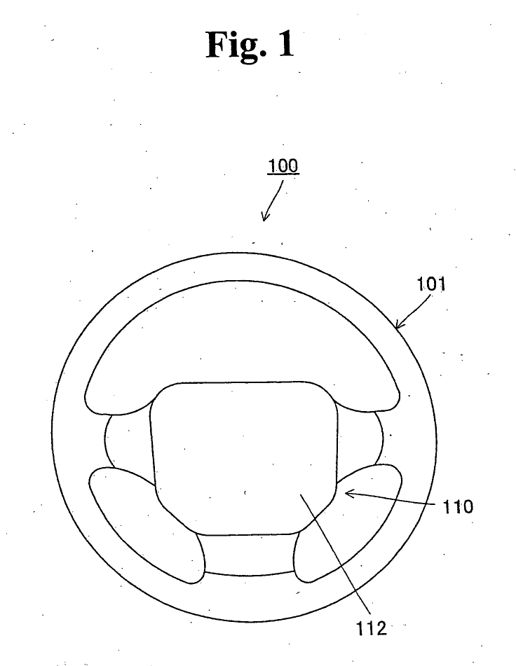

Referring to FIGS. 1 to 7, an automotive vehicle steering device 100 is provided with an embodiment of the invention, as will be described.

FIG. 1 is a plan view showing the appearance of an automotive device wheel 100 to which an embodiment of the invention is applied. As shown in FIG. 1, the steering device 100 of this embodiment principally includes a steering wheel section 101 which is manipulated by a vehicle occupant, an airbag module 110 covered with a horn pad 112 inside the outline of the steering wheel 101, and a horn switch to be described later. The steering wheel 101 is constructed such that a ring-shaped metal core is coated with an urethane resin. The horn pad 112 is arranged to activate the horn in response to its depression. The function of the covering the occupant side of an airbag 118, will be described later, and will be referred to as a “a module cover.” The horn pad 112 serves as the “depression part” of the embodiment.

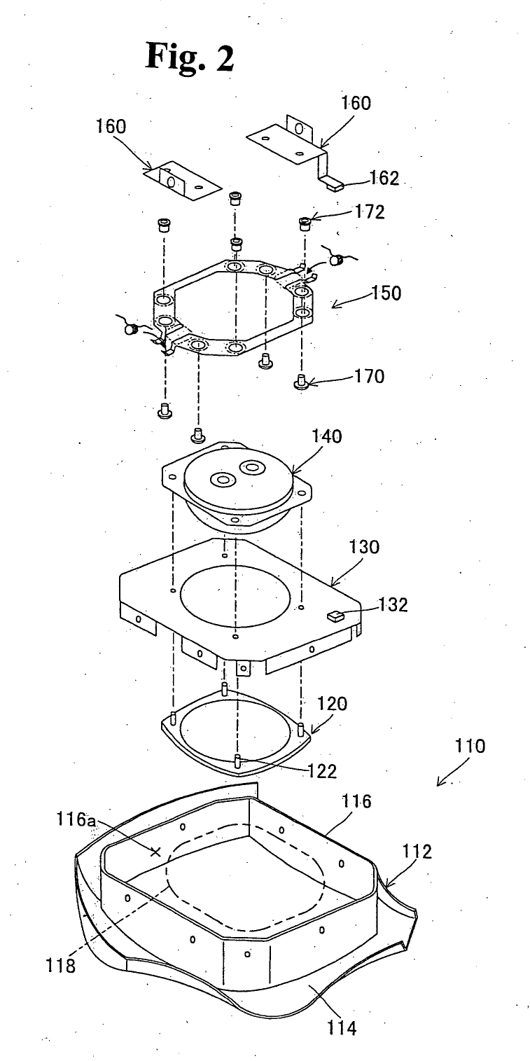

FIG. 2 is an exploded perspective view of the airbag module 110 of the steering device 100. As shown in FIG. 2, the horn pad 112 includes a cover flat part 114 serving as depression part to be depressed in operating the horn and a leg 116 that rises upright from the cover flat part 114. An accommodation space 116a partitioned by the leg 116 of the horn pad 112 accommodates principal components such as the airbag 118, a bag ring 120, a retainer 130, an inflator 140, a link mechanism 150, and a bracket 160 in modules on the back of the horn pad 112. The airbag module 110 serves as “the airbag system” of the invention.

The airbag 118 deploys toward an occupant protection region in a collision. The airbag 118 is mounted to the retainer 130 via the bag ring 120. The airbag 118 that is folded in a specified form in advance is accommodated in the retainer 130. The inflator 140 has the function of supplying inflation gas to the airbag 118.

The link mechanism 150 is disposed on the part at which the bracket 160 as the steering wheel (101) side member and the retainer 130 as the horn pad (112) (depression part) side member are opposed. As will be described later, the link mechanism 150 is fixed to the bracket 160 with guide bolts 170 to be screwed in the thread grooves of the bracket 160 and fixed to the fixing part of the steering wheel 101 via the bracket 160. Further, the link mechanism 150 is fixed to the bag ring 120 with guide nuts 172 which are screwed on the threads 122 of the bag ring 120, with the retainer 130 and the inflator 140 interposed therebetween.

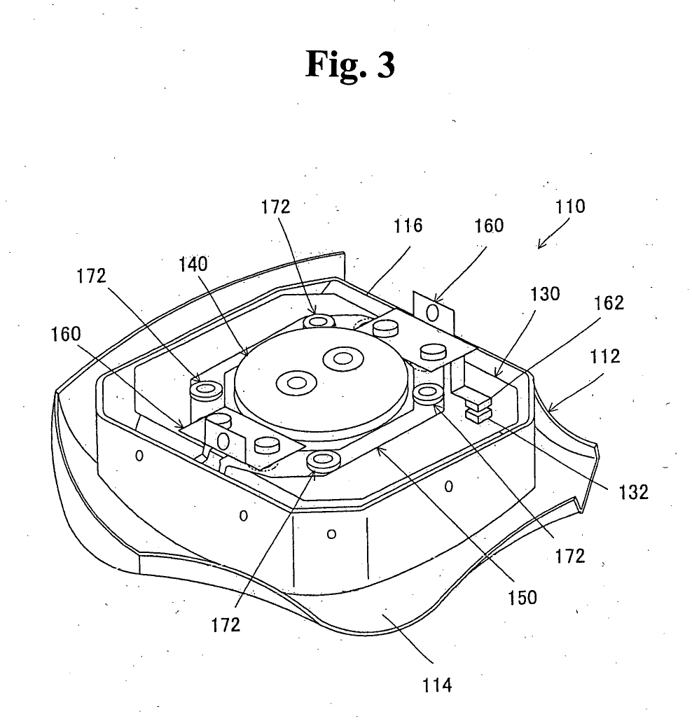

FIG. 3 shows the airbag module 110 viewed from the back. As shown in FIG. 3, the link mechanism 150 is fixed to the retainer 130 with the four guide nuts 172 and the bag ring 120. The guide nuts 172 and the bag ring 120 are also used as fixing means for fixing the inflator 140 to the retainer 130.

Specifically, according to this embodiment, the guide nuts 172 and the bag ring 120 (a bolt-nut structure) are used as both fixing means for fixing the link mechanism 150 to the retainer 130 close to the horn pad 112 and fixing means for fixing the inflator 140 to the retainer 130 close to the horn pad 112. The guide nuts 172 and the bag ring 120 serve as “the first fixing means” and “the second fixing means” of the invention. In place of the bolt-nut structure, a rivet structure can be used.

The retainer 130 has a first horn switch contact 132 that comprises a part of the horn switch. The bracket 160 has a second horn switch contact 162 that comprises another part of the horn switch. The first horn switch contact 132 and the second horn switch contact 162 come into contact with each other via the link mechanism 150 that comprises a further part of the horn switch, to turn on (viz., close) the horn switch, thereby establishing an electrical circuit and sounding the horn.

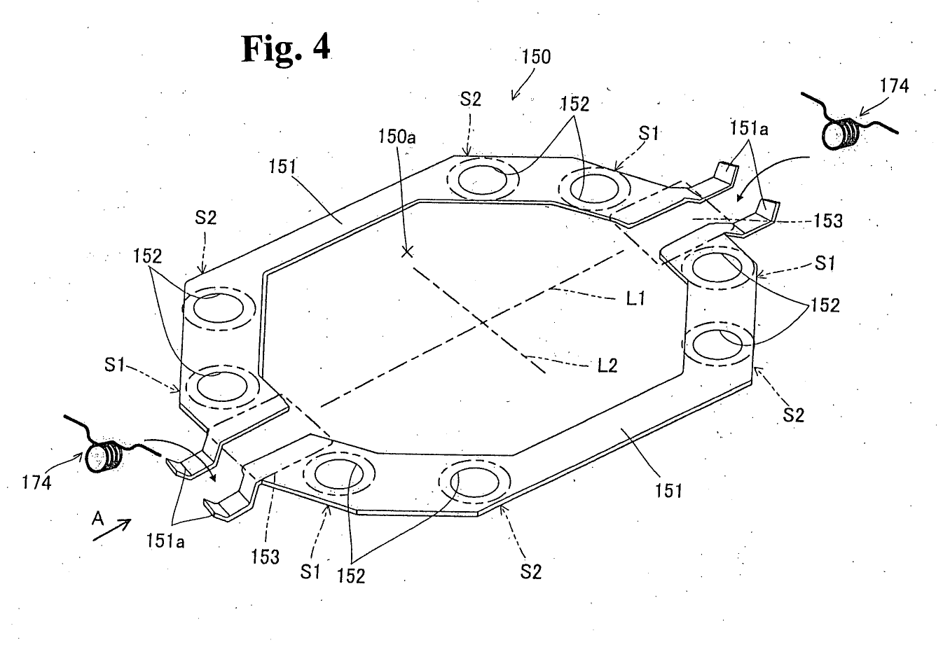

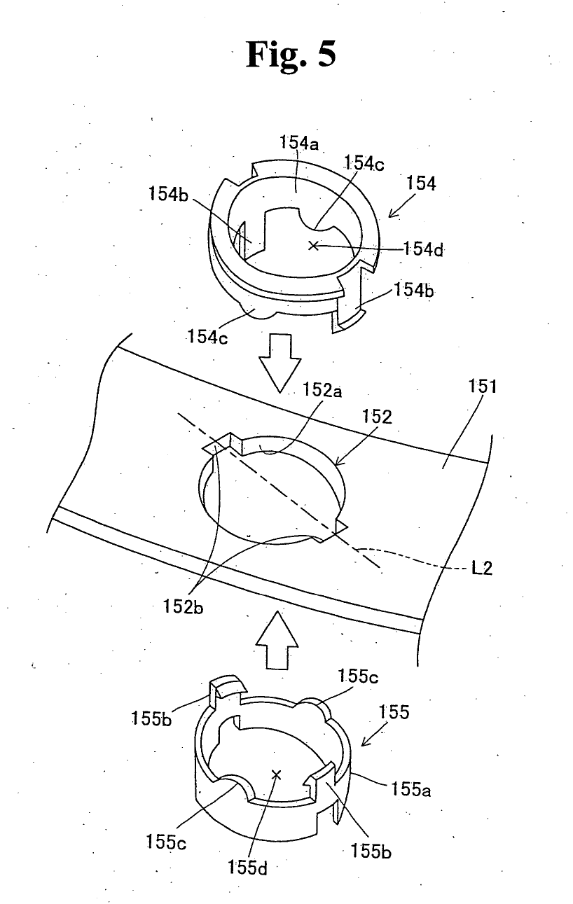

Referring to FIGS. 4 and 5, the specific structure of the link mechanism 150 will be described. FIG. 4 is a perspective view of the link mechanism 150 according to the embodiment. FIG. 5 is an enlarged view of the part of the link mechanism 150 in position S2 of FIG. 4.

As shown in FIG. 4, the link mechanism 150 includes a pair of right and left (bilaterally symmetrical) plate-like horn plates 151. The bilaterally symmetrical right and left horn plates 151 are effective to reduce the cost because they can be used in common. Each horn plate 151 has four through holes 152 in total. The horn plates 151 are joined together with connecting members 153 adjacent the ends 151a. The horn plates 151 joined with the connecting or joint members 153 form a ring shape having a central hole 150a. The central hole 150a is fitted on the projection of the inflator 140 disposed adjacent to the horn plates 151. Although not shown in the drawing, the pair of right and left horn plates 151 are disposed in a ring shape along the outline of the horn pad 112 as seen in plan.

As the details will be described later, the joint members 153 that join the horn plates 151 have two coil springs 174 for elastically biasing both ends 151a of the horn plates 151.

As shown in FIG. 5, each through hole 152 has a circular part 152a and notches 152b at two places of the outer periphery of the circular part 152a. The notches 152b are formed on the axis (axis L2 in FIGS. 4 and 5) orthogonal to the axis (axis L1 in FIG. 4) of the horn plates 151. In each through hole 152 at position S2 in FIG. 4, a first insulator 154 is fitted from above in FIG. 5 and a second insulator 155 is fitted from below in FIG. 5.

The first insulator 154 has a substantially cylindrical main body 154a having a hole 154d, claws 154b extending from two places of the main body 154a, and semicircular projections 154c extending from two places of the main body 154a. The second insulator 155 has a substantially cylindrical main body 155a having a hole 155d, claws 155b extending from two places of the main body 155a, and semicircular projections 155c extending from two places of the main body 155a. Both the first insulator 154 and the second insulator 155 are made of resin.

When the first insulator 154 and the second insulator 155 are fitted into each through hole 152, the claws 154b of the first insulator 154 are fitted in the notches 152b, and the claws 155b of the second insulator 155 are fitted in the notches 152b. Since the claws 154b of the first insulator 154 are fitted into the main body 155a of the second insulator 155, and the claws 155b of the second insulator 155 are fitted in the main body 154a of the first insulator 154, the first insulator 154 and the second insulator 155 are crimped to the horn plates 151 from both sides. In this crimped state, the semicircular projections 154c that project downward from the main body 154a of the first insulator 154 are in contact with the upper surface of the horn plates 151, while the semicircular projections 155c that project upward from the main body 155a of the second insulator 155 are in contact with the lower surface of the horn plates 151. The horn plates 151 are thus clamped from both sides by the first insulator 154 and the second insulator 155. The projections 154c of the first insulator 154 and the projections 155c of the second insulator 155 extend longitudinally along the axis L2. This allows the motion of the horn plates 151 relative to the first insulator 154 and the second insulator 155 by the cooperation of the projections 154c and the projections 155c, with the first insulator 154 and the second insulator 155 crimped to the horn plates 151. The motion follows the extending direction of the projections 154c and the projections 155c, thus being limited to the longitudinal section of the axis L2 on which the notches 152b of the through hole 152 are provided.

In this crimped state, the hole 154d of the first insulator 154 and the hole 155d of the second insulator 155 are disposed on top on one another at the upper part and the lower part of the through holes 152, forming a through hole as a whole. The through hole is used to pass the guide nut (the guide nut 172 in FIG. 2) for fixing the first insulator 154 and the second insulator 155 to the retainer 130 and the guide bolt (the guide bolt 170 in FIG. 2) for fixing them to the bracket 160 adjacent to the steering wheel 101 there through.

For each through hole 152 at position S1 in FIG. 4, or the through hole 152 closer to the end of the horn plate than to position S2, the positions of the first insulator 154 and the second insulator 155 are opposite vertically from that in position S2. Specifically, in the through hole 152 at position S, the second insulator 155 is fitted from above in FIG. 5; the first insulator 154 is fitted from below in FIG. 5.

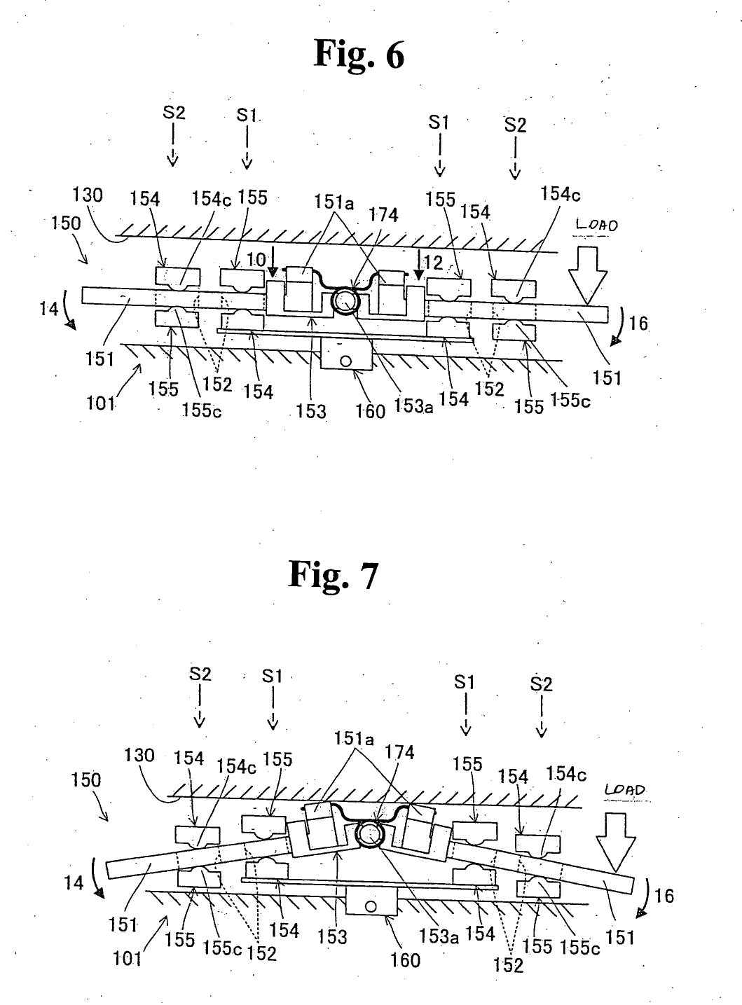

FIGS. 6 and 7 show the link mechanism 150 in FIG. 4 viewed from arrow A, with the first insulators 154 and the second insulators 155 crimped to the horn plates 151. FIG. 6 shows a state before the horn pad 112 is depressed; and FIG. 7 shows a state when the horn pad 112 is depressed. FIGS. 6 and 7 show the link mechanism 150 in FIG. 4 upside down.

As shown in FIG. 6, the link mechanism 150 is interposed between the steering wheel 101 and the retainer 130. In the link mechanism 150, the horn plates 151 are clamped at the positions of the through holes 152 by the projections 154c of the first insulator 154 and the projections 155c of the second insulator 155.

In the through hole 152 on the inside of FIG. 6, or at positions S1 in FIG. 4 (which corresponds to “the first support section” in the invention), the first insulator 154 and the second insulator 155 that clamp the horn plate 151 from both sides are fixed to the bracket 160 adjacent to the steering wheel 101 with the guide bolt (the guide bolt 170 in FIG. 2) fitted in the through hole 152. The first insulator 154 and the second insulator 155 at position S1 serve as “the first support means” and “the first clamp means” of the invention.

On the other hand, in the through hole 152 on the outside in FIG. 6, or at position S2 in FIG. 4 (which corresponds to “the second support section” of the invention), the first insulator 154 and the second insulator 155 that clamp the horn plate 151 from both sides are fixed to the retainer 130 with the guide nut (the guide nut 172 in FIG. 2) fitted in the through hole 152.

The horn plates 151 can rotate around the rotation shaft 153a of the joint member 153, whose ends 151a are elastically biased in the direction of arrow 10 or arrow 12 by the coil springs 174. In other words, the coil springs 174 have the function of elastically biasing the horn plates 151 so as to rotate in the direction opposite to arrow 14 or arrow 16 in FIG. 6. The rotation shaft 153a of the joint member 153 has a cylindrical mounting part, on which the winding part of the coil spring 174 is fitted to fix the coil spring 174 to the joint member 153.

When the horn pad 112 is depressed to sound the horn in the condition shown in FIG. 6, the load is applied to the part substantially in the center of each horn plate 151 (the right and left ends in FIG. 6) of the link mechanism 150 via the retainer 130. At this time, the lower surface of the retainer 130 moves toward the upper surface of the steering wheel 101 (downward in FIG. 6), and with this motion, the first insulator 154 and the second insulator 155 disposed outside in FIG. 6, which are fixed to the retainer 130, are also moved downward in FIG. 6.

In other words, the first insulator 154 and the second insulator 155 disposed outside in FIG. 6 (at position S2 in FIG. 4) move relative to the first insulator 154 and the second insulator 155 disposed inside in FIG. 6 (at position S1 in FIG. 4). Accordingly, the horn plates 151 can rotate in a specified direction (in the direction of arrow 14 or arrow 16 in FIG. 6) around the rotation shaft 153a while being clamped by the projection 154c of the first insulator 154 and the projection 155c of the second insulator 155. Thus, as shown in FIG. 7, the horn plates 151 rotate in the direction of arrow 14 or arrow 16 (which corresponds to “the second rotating direction” in the invention) against the elastically biasing force of the coil spring 174 around the rotation shaft 153a of the joint member 153.

At this time, according to this embodiment, the first horn switch contact 132 of the retainer 130 and the second horn switch contact 162 of the bracket 160, shown in FIG. 2, move relative to one another in the direction in which they approach and contact each other. Since the first horn switch contact 132 and the second horn switch contact 162 come into contact with each other, the horn switch is closed to sound the horn.

When the depression of the horn pad 112 is released to terminate the sounding of the horn (depicted in FIG. 7), the load applied to the horn plates 151 by the depressing force is decreased. At that time, the lower surface of the retainer 130 moves in the direction separating from the upper surface of the steering wheel 101 (upward as seen in FIG. 7), with which the first insulator 154 and the second insulator 155 disposed outside in FIG. 7 (at position S2 in FIG. 4), which are fixed to the retainer 130, are also moved upward in FIG. 7. Accordingly, the horn plates 151 rotate in the direction opposite to arrow 14 or arrow 16 by the elastically biasing force of the coil spring 174 around the rotation shaft 153a of the joint member 153 while being clamped by the projection 154c of the first insulator 154 and the projection 155c of the second insulator 155. Thus, the horn plate 151 returns from the state shown in FIG. 7 to the state shown in FIG. 6. At that time, according to the embodiment, the first horn switch contact 132 of the retainer 130 and the second horn switch contact 162 of the bracket 160, shown in FIG. 2, move relative to one another and in the direction in which they separate from each other. Since the contact of the first horn switch contact 132 and the second horn switch contact 162 is released, the horn switch is turned off (opened) to turn off the horn.

As has been described, in the steering device that mounts the link mechanism 150 of the embodiment, since the guide nuts 172 and the bag ring 120 serve as both of fixing means for fixing the link mechanism 150 to the retainer 130 and fixing means for fixing the inflator 140 to the retainer 130, the number of components can be reduced, increasing the versatility of the components to decrease the cost, thereby achieving the realization of the device.

According to this embodiment, the motion of the horn pad (module cover) 112 during the operation of the horn is limited to one direction by the rotation of the horn plates 151 in a specified direction (in the direction of arrow 14 or arrow 16 in FIG. 6). Also, the embodiment uses a structure in which the pair of right and left horn plates 151 is disposed in ring form along the outline of the horn pad 112 in plan view. Accordingly, whichever part of the horn pad 112 such as the center or the end, the occupant of the vehicle depresses, the pressure by the depression is applied evenly onto the horn pad 112, allowing the pressure required to sound the horn to be maintained constant irrespective of the depression position of the horn pad 112, thus smoothing the motion (increasing the operability of the horn).

According to the embodiment, since the motion of the horn pad 112 is limited to one direction during the operation of the horn, the gap between the outer periphery of the horn pad 112 and the steering wheel 101 can be minimized, enhancing the appearance of the steering device.

According to the embodiment, since the central hole 150a formed by the horn plates 151 is fitted on the projection of the inflator 140, the space in which the existing airbag module 110 is to be disposed can be used effectively, and the structure in which the horn plates 151 are disposed around the inflator 140 is particularly effective in reducing the height. This is therefore advantageous in reducing the height of an airbag system and a steering device to achieve size reduction.

The invention is not limited to the foregoing embodiment and various adaptations and modifications can be made without departing from the scope of the appended claims. Merely by way of example, the following variants can be made.

The foregoing embodiment has been described for the case in which the fixing means for fixing the link mechanism 150 to the retainer 130 is also used as the fixing means for fixing the inflator 140 to the retainer 130. However, the invention may alternatively use a structure in which the fixing means for fixing the link mechanism 150 to the retainer 130 is also used as means for fixing another member adjacent to the horn pad 112, other than the inflator 140, to the retainer 130.

The foregoing embodiment has been described for the case in which the link mechanism is constructed of two horn plates. Alternatively, an embodiment of the invention may be such that the link mechanism is constructed by combining three or more horn plates as appropriate.

The foregoing embodiment has been described for the case in which the horn plates are fitted on the projection of the inflator 140 adjacent to the horn plates through the central hole. Alternatively, the invention may be embodied by a structure in which the horn plates are not fitted on the projection of the inflator 140.

Although the disclosed embodiment uses coil springs 174 as biasing means for biasing the horn plates 151, embodiments of the invention may use other means as the biasing means, such as a leaf spring with a known structure, a damper mechanism (using air pressure or fluid pressure), and means using the restoring force of the material itself.

Although in the embodiment the horn pad 112 is also used as the airbag cover, the invention may use the horn pad 112 only for operating the horn, separately from the airbag cover. Although in the embodiment the horn pad 112 operates together with the member on the retainer 130 side, the invention may be embodied by a structure in which the horn pad 112 operates in isolation from the member on the retainer 130 side, that is, a so-called cover floating (pad floating) type in which the horn pad 112 floats on the retainer 130.

Although in the disclosed embodiment the structure of the steering device for an automotive vehicle has been described, the invention is applicable to the structure of the steering device of vehicles other than automotive vehicles, for example, floating/flying vessels, trains and the like.

The disclosure of Japanese Patent Application No. 2004-277288 filed on Sep. 24, 2004 is incorporated herein.

What is claimed is:

1. A horn switch device provided between a steering-wheel associated member and a depression-part associated member, comprising:
a first horn switch member and a second horn switch member installed between the steering-wheel associated member and the depression-part associated member, and
first fixing means for fixing said first horn switch member to the depression-part associated member, said first fixing means further fixing a plurality of depression-part side members forming the depression-part associated member.

2. A horn switch device according to claim 1, wherein said first and second horn switch members include switch contacts such that the switch contacts are brought into contact with each other by manual depression of the depression-part associated member to sound a horn, and the switch contacts are separated by removal of the manual depression to cease sounding of the horn.

3. A horn switch device according to claim 1, wherein said first horn switch member comprises
a plurality of plate-like horn plates joined together with a rotation shaft to rotate therearound and including first and second support sections; first support means that supports the first support sections and is fixed to a steering-wheel side member; second support means that fixes second support sections of the horn plate, different from the first support sections, and is fixed to the depression-part side member via the first fixing means; and biasing means that biases the horn plates so as to rotate around the rotation shaft in a first rotating direction.

4. A horn switch device according to claim 3, wherein said horn plates are arranged such that when the depression-part side member is brought close to the steering-wheel side member by the depression of the depression part to move the first support means and the second support means relative to one another, the horn plates rotate in a second rotating direction opposite to the first rotating direction around the rotation shaft against the biasing force of the biasing means, with the first support section supported to the steering wheel side member by the first support means and the second support section supported to the depression part side member by the second support means, to bring a first horn switch contact into contact with a second horn switch contact; and when the depression-part side member is separated from the steering-wheel side member by releasing the depression of the depression part to move the first support means and the second support means relative to one another, the horn plates rotate in the first rotating direction around the rotation shaft by the biasing force of the biasing means, with the first support section supported to the steering wheel side by the first support means and the second support section supported to the depression part side by the second support means, to release the contact between the first horn switch contact and the second horn switch contact.

5. A horn switch device according to claim 3, wherein the plurality of horn plates includes a pair of right and left horn plates.

6. A horn switch device according to claim 5, wherein the plurality of horn plates is joined together to form a ring shape having a central hole, the central hole being fitted on a horn-plate adjacent member.

7. A horn switch device according to claim 3, wherein
the first support means includes first clamp means that is fixed to the steering-wheel side member while clamping the first support section of each horn plate from top and bottom of the plate and allows rotation of the horn plates around the rotation shaft in the clamped state; and
the second support means includes second clamp means that is fixed to the depression-part side member while clamping the second support section of each horn plate from top and bottom of the plate and allows the rotation of the horn plates around the rotation shaft in the clamped state.

8. An airbag system comprising:
the horn switch device according to claim 1;
a vehicle airbag that deploys in an occupant protection region in a collision;
a retainer that accommodates the vehicle airbag folded in advance;
an inflator that supplies inflation gas to the vehicle airbag;
an airbag cover that covers a part of the vehicle airbag adjacent to an occupant; and
a horn operating member,
wherein a horn is activated by a depressing force applied to the horn operating member which serves as the depression part, and wherein an operation of the horn is cancelled by removing depressing force from the horn operating member.

9. A steering device comprising:
a steering wheel for steering a vehicle, to which the horn switch device according to claim 1 is mounted;
a vehicle airbag that deploys in an occupant protection region in a collision;
a retainer that accommodates the vehicle airbag folded in advance;
an inflator that supplies inflation gas to the vehicle airbag;
an airbag cover that covers a part of the vehicle airbag adjacent to an occupant inside the steering wheel; and
a horn operating member provided to the steering wheel,
wherein a horn is activated by depression of the horn operating member serving as the depression part and operation of the horn is cancelled by canceling depression of the horn operating member.
